(19) United States
(12) Patent Application Publication
(10) Pub. No.: US 2017/0346889 A1
(43) Pub. Date: Nov. 30, 2017

(54) CO-LOCATING APPLICATION INSTANCES

(71) Applicant: LinkedIn Corporation, Mountain View, CA (US)

(72) Inventors: Zhenyun Zhuang, Belmont, CA (US); Jui Ting Weng, Sunnyvale, CA (US); Cuong Tran, Los Altos, CA (US); Haricharan Ramachandra, Fremont, CA (US); Badrinath Sridharan, Saratoga, CA (US)

(21) Appl. No.: 15/169,240

(22) Filed: May 31, 2016

(51) Int. Cl. H04L 29/08

(52) U.S. Cl. CPC H04L 67/1008

(57) ABSTRACT

Techniques are provided for assigning application instances to different machines. Resource usage of a particular resource by multiple application instances over a period of time is determined. Two or more application instances may be assigned to the same machine if the combined resource usage of the application instances does not exceed the resource capacity of the machine. One or more different types of resources may be considered for machine assignment, such as CPU, memory, network I/O, and disk I/O.

### TECHNICAL FIELD

The present disclosure relates to resource management and, more particularly, to co-locating multiple application instances on the same machine in order to reduce the number of machines that are needed to support a workload while avoiding exceeding the resource capacities of the machines.

### BACKGROUND

Internet companies typically leverage multiple types of applications, each type using different types of computing resources at different levels. For example, one type of application may require a significant disk I/O while another type of application requires a significant amount of memory. Each application type may also have different clusters supporting different use cases. These use cases, depending on the traffic types and requirements, may also expose different degrees of resource usage of each individual resource type.

One approach to allocating machines to host application instances is to “scale out” application clusters by deploying multiple instances, each serving a portion of a workload. Given the many types of applications, many use cases of each application type, and multiple machine clusters, the total number of machines used may be significant, such as tens of thousands of machines in each data center, resulting in a cost of tens of millions of dollars per data center.

However, many machines in a data center (if not all) might be only lightly used. Not only might many computing resources of the machine be rarely used, but even the most used resource type (e.g., the central processing unit (CPU)) might only experience substantial levels of load during certain time periods. For example, for a CPU heavy cluster of application instances of one type, all other resources, such as disk and memory, are rarely used. Even for CPU usage, CPU usage may be relatively low most of the time. For example, it may be common to see 98% idle CPU.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram that depicts a process for assigning application instances to machines, in an embodiment;

FIGS. 2A-2B are diagrams that depict, respectively, a chart illustrating CPU usage of a first application instance and a chart illustrating CPU usage of a second application instance;

FIG. 2C is a diagram that depicts a chart illustrating combined CPU usage of both application instances, in an embodiment.

FIG. 3 is a flow diagram that depicts a process for assigning application instances to machines, in an embodiment;

FIGS. 4A-4B are diagrams that depict cyclic online user behavior and cyclic resource usage;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for intelligently packing multiple application instances on a single machine or computing device. The more application instances that can execute on a machine, the fewer machines that are required to host all the application instances, resulting in greater savings in financial cost, space (to place or store the machines), and maintenance.

In one technique, each application instance is associated with time series data that indicates, for each of multiple points in time, a level of usage of a particular resource, such as CPU or memory, over a period of time. Sets of time series data of multiple application instances are combined (e.g., added) to determine whether the combination would result in exceeding the capacity of the particular resource. Multiple application instances are “packed” or assigned to a machine until the machine's resource capacity is reached.

In a related technique, instead of considering just one type of resource of a machine, multiple types of resources are considered. Thus, when determining whether to assign an application instance to a machine that is already assigned one or more other application instances, multiple sets of time series data (one set for each resource) of the application instance are combined, respectively, with multiple sets of accumulated time series data associated with the machine.

### Time Series Data

An application instance's usage of a particular resource includes time series data, which comprises multiple data values, each data value corresponding to (a) a different instant in time over a particular time period or (b) a different period of time within the particular time period. Example time periods include a 12 hours, a day, a week, two weeks, a month, or any other time period.

Usage measurements may be generated and recorded at different intervals, such as every 50 milliseconds, every second, or every five seconds. A usage measurement may reflect usage of a computer resource at a particular instant in time or over a period of time, such as one second or five seconds. For example, a recorded usage measurement may be an average of five usage measurements.

As a specific example, if resource usage corresponds to a week's time and usage measurements are recorded at 15-minute intervals, then the application instance's usage comprises 672 values for the particular resource. In this example, if time series data of two application instances are added together, then such an adding involves 672 addition operations. After adding, if any of the 672 values exceed the resource capacity of a machine, then both application instances cannot be executed on the machine.

Time series data of an application instance may be represented as a single dimensional vector or array of values. Thus, given the previous example, the vector or array may comprise 672 entries, each containing a single data value.

### Example Process

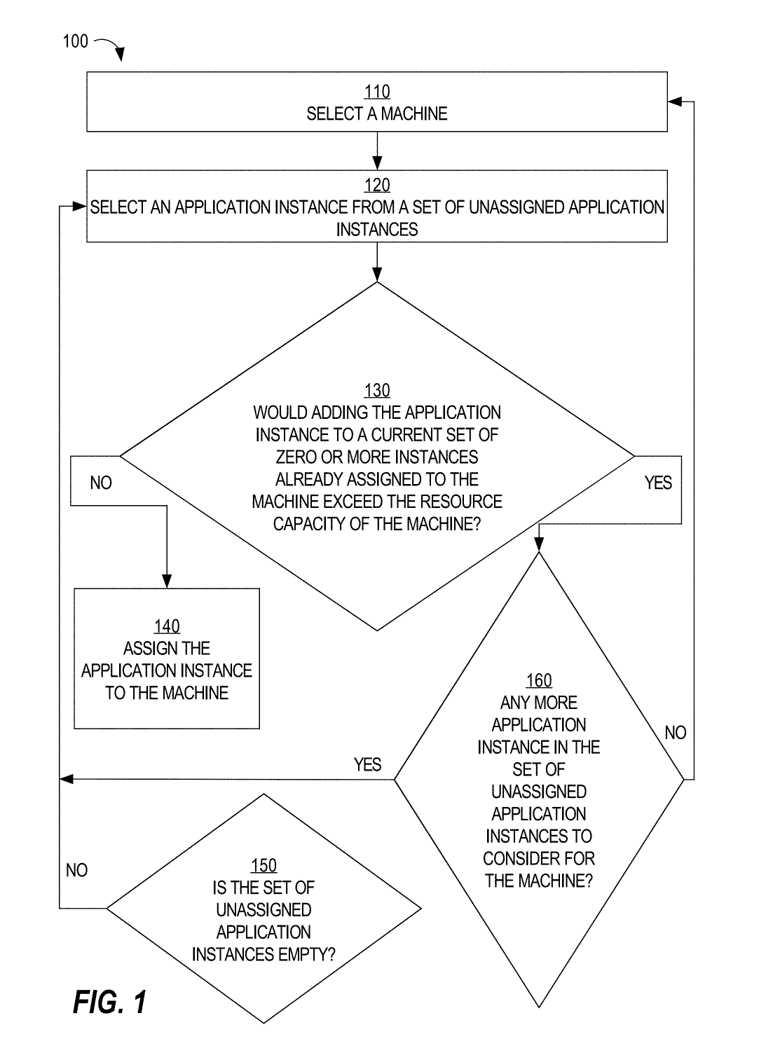

FIG. 1 is a flow diagram that depicts a process 100 for assigning application instances to machines, in an embodiment. Process 100 may be implemented in hardware, software, or any combination of hardware and software. Process 100 begins with a set of unassigned application instances, a set of machines, and, for each machine in the set of machines, a set of assigned application instances that is initially empty.

Each application instance in the sets may be of a single type of application or may be one of multiple types of applications. For example, there may be 45 instances of Application A and 23 instances of Application B, where each application type performs different types of tasks relative to each other. Each application instance may be responsible for operating on a different set of data. For example, in a social networking context, one application instance may be responsible for processing requests from users with member identifiers in a certain set of identifiers and another application instance may be responsible for processing requests from users with member identifiers in a different set of identifiers.

Each machine is a computing device that comprises multiple types of resources, such as one or more CPUs, memory, persistence storage, storage I/O, and/or network I/O. Thus, some machines may be physically (and communicatively) coupled to other machines in the same data center. Each application instance uses a different amount of resources of each type over time, even relative to other application instances of the same type. For example, some application instances may be responsible for processing user requests from users residing in Asia and other application instances may be responsible for processing user requests from users residing in South America. Not only are such users (in the aggregate) on a different sleep schedule and, thus, submit requests at different times of the day, such users may differ in terms of frequency of the requests.

At block 110, a machine is selected. Each machine may have the same resource capacities. For example, all machines that are considered in process 100 may have the same CPU capability (e.g., 8 GHz), the same amount of memory (e.g., 10 GB), the same storage/disk I/O capability (e.g., 100 MB/s of IO rate for a HDD or hard drive disk), the same storage capacity (e.g., 2 Terabytes), and the same network I/O capability (e.g., 10 Gigabit). Alternatively, different machines have different resource capacities. For example, one machine may have a single 8 GHz processor and another machine may have two 16 GHz processors.

At block 120, select an application instance from the set of unassigned application instances. Block 120 may involve selecting a random application instance from the set of unassigned application instances. Alternatively, block 120 may involve selecting an application instance based on one or more criteria, such as level of resource usage, which is described in more detail below.

At block 130, determine whether adding the selected application instance to the set of assigned application instances (corresponding to the selected machine) would exceed the resource capacity of the selected machine. If not, then process 100 proceeds to block 140. Else, process 100 proceeds to block 160. The set of assigned application instances corresponding to the selected machine is referred to hereinafter as the “current set of instances.”

When determining whether the accumulated time series data of multiple application instances would exceed the resource capacity of a machine, the specific resource capacity of the selected machine is considered if different machines (selected in the current implementation of process 100) have different resource capacities.

Block 130 may involve adding the selected application instance's resource usage (comprising time series data) to the accumulated resource usage (also comprises time series data) associated with the selected machine to generate an updated accumulated resource usage and comparing the updated accumulated resource usage to a resource capacity, where the accumulated resource usage is based on the application instance(s) that is/are already in the current set of instances. For example, if the respective time series data comprises 672 data values, then adding one set of time series data to another set of time series data would involve 672 addition operations and result in 672 data values. For example, if the resource type is CPU and the time series data includes percentage CPU, then, for each point in time for which there is a data point, two percentages are added (e.g., 22% and 39%). Because different machines have different resource capacities, some of the percentages that are added may first be scaled. For example, if an application instance on a machine with a 8 GHz processor required 52% CPU at time T and the selected machine in process 100 has a 16 GHz processor, then the 52% may be halved to generate 26%.

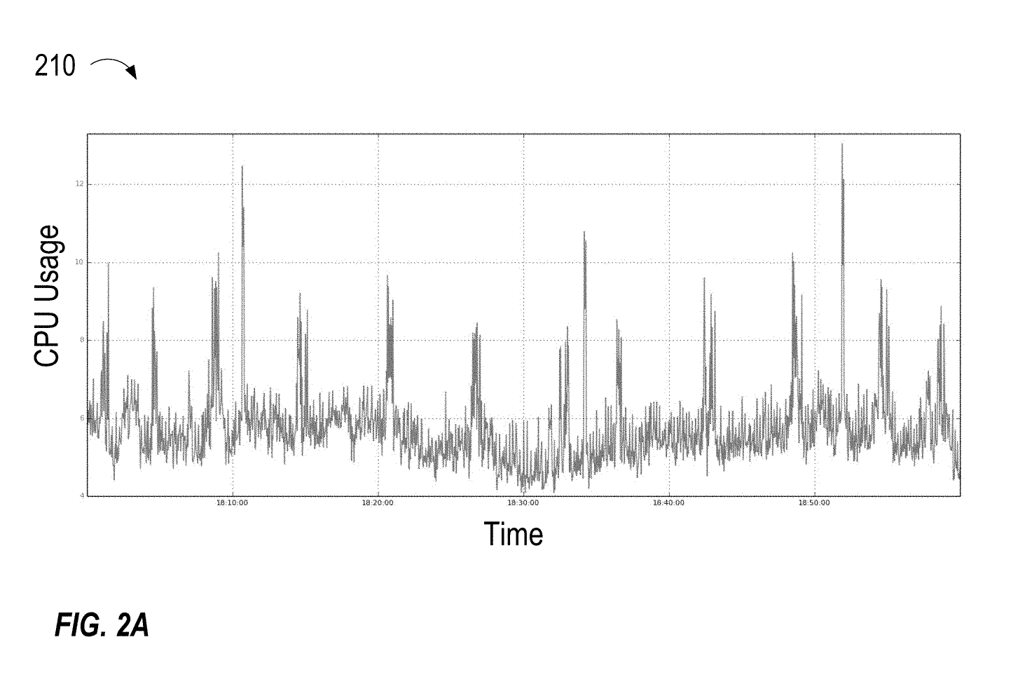

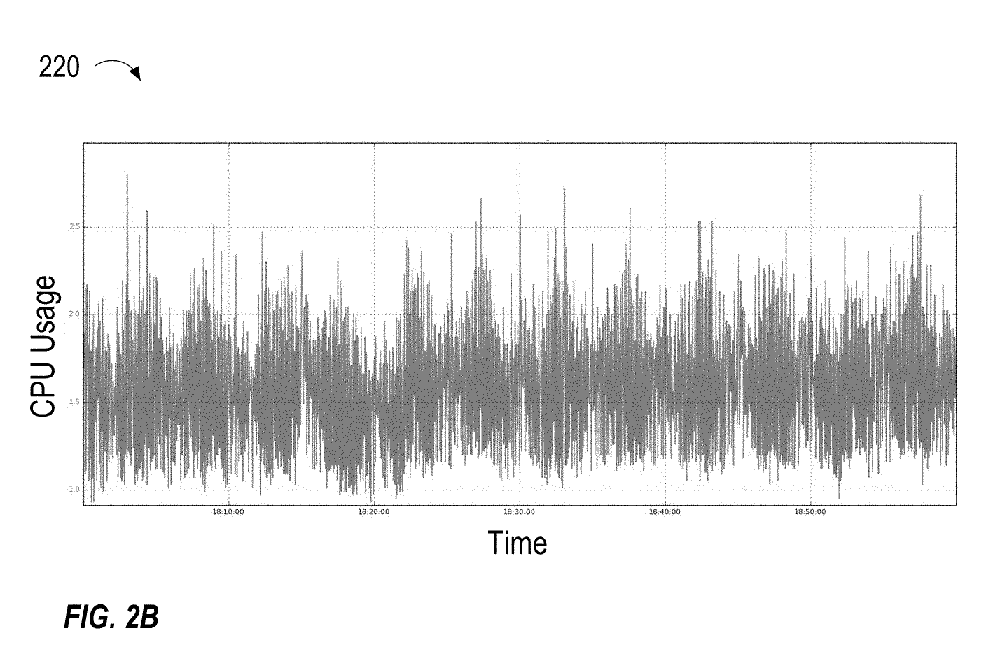

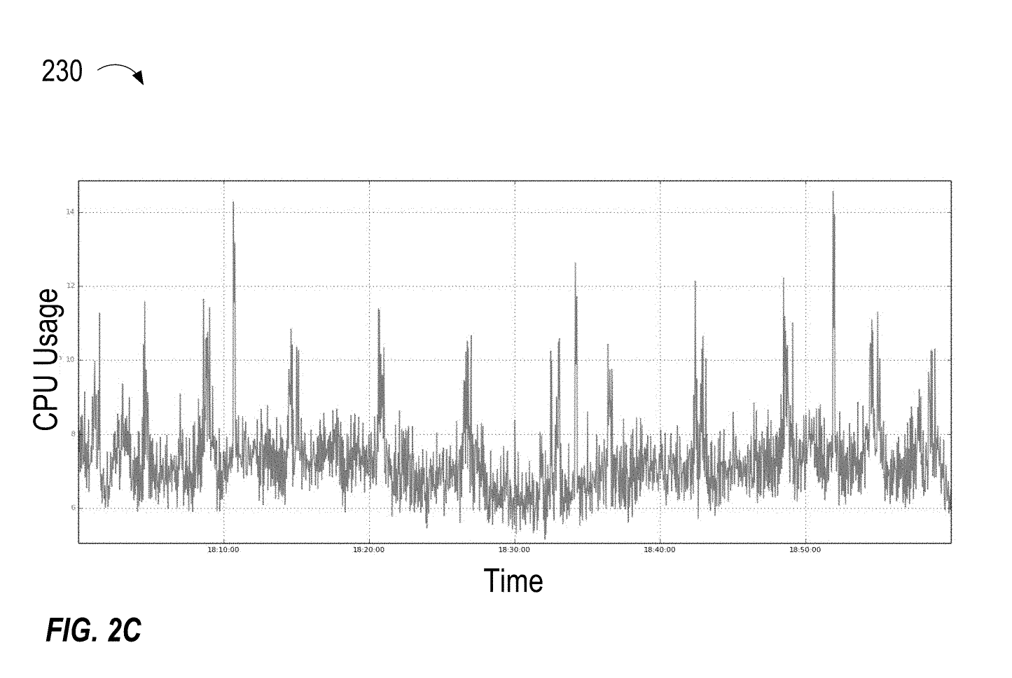

FIGS. 2A-2B are diagrams that depict, respectively, a chart 210 illustrating percentage CPU usage of a first application instance and a chart 220 illustrating percentage CPU usage of a second application instance. The x-axis on each chart represents time. The y-axis on each chart represents CPU usage; however, the y-axis on chart 210 is from 4% to between 12% and 14% and the y-axis on chart 220 is from just under 1% to between 2.5% and 3%

FIG. 2C is a diagram that depicts a chart 230 illustrating combined CPU usage of both application instances. The illustrated combined CPU usage is a rough estimate of what CPU usage might be like if the first application instance runs on the same machine as the second application instance. The x-axis on chart 230 is the same as the x-axes on charts 210 and 220. In other words, the three charts have the same overall time period. The y-axis on chart 230 is from just under 6% to just over 14%.

If adding the selected application instance does not exceed the resource capacity of the selected machine, then process proceeds to block 140, where the selected application instance is added to the current set of instances.

In an embodiment, process 100 may be optimized by skipping block 130 if the current set of instances is empty (i.e., no application instance has yet been assigned to the selected machine). In this scenario, process 100 skips block 130 and proceeds to block 140, where the selected application instance is added to the current set of instances, which effectively assigns the selected application instance to the selected machine.

Block 140 also involves removing the selected application instance from the set of unassigned application instances. The act of removing the selected application instance from the set of unassigned application instances ensures that the selected application instance is not considered again during the current assignment process.

At block 150, it is determined whether the set of unassigned application instances is empty. If so, then process 100 ends. Else process 100 proceeds to block 120, where another application instance is selected.

At block 160 (where adding the selected application instance would exceed the resource capacity of the selected machine), it is determined whether there are any more application instances in the set of unassigned application instances that have not been considered for the selected machine (or “unconsidered application instances”). If so, process 100 returns to block 120 where an unconsidered application instance is selected. Else, process 100 returns to block 110, where a different machine is selected.

### Fuzzy Capacity Threshold

As described previously, block 130 involves determining whether assigning an application instance to a machine would result in the resource capacity of the machine being exceeded. In an embodiment, exceeding the resource capacity of a machine may be defined as any resulting data value of the summation of two sets of time series data (which may comprise many data values) being greater than a particular capacity threshold.

In an alternative embodiment, a single data value in the summation of two sets of time series data does not automatically result in excluding the corresponding application instance from consideration with respect to the currently selected machine. For example, less than five data values in a summation of two sets of time series data may be acceptable. Instead of an absolute number of data values, exceeding the resource capacity may be defined as a percentage. For example, if greater than 10% of the data values in the summation of two sets of time series data exceed a defined capacity threshold of the relevant resource, then the corresponding application instance is not assigned to the selected machine.

### Multiple Resource Types

While process 100 implies that only a single resource is considered for assigning application instances to a machine, process 100 may involve considering resource usage of multiple resource types. For example, CPU usage and memory usage of each application instance may be considered. Thus, block 130 may involve adding CPU usage of a selected application instance to an accumulated CPU usage and adding memory usage of the selected application instance to an accumulated memory usage. If either updated accumulated usage exceeds to the resource capacity of the selected machine, then process 100 would proceed to block 160.

### Zig Zag Approach

By following the approach of process 100, a different number of application instances may be assigned to different machines. For example, ten application instances may be assigned to one machine and two application instances may be assigned to another machine. However, there are at least two problems with this scenario. First, there is a cost to having many application instances execute on a single machine: context switching. The more application instances are running on a machine, the more processing time will be required for the increased context switching activity. Second, management becomes more difficult. For example, a monitoring system that monitors each instance from each machine may display the monitored values to people and/or may feed the values into other components (e.g., for anomaly detection). People monitoring a system of multiple machines generally prefer that each machine runs an equal number of application instances. One way to ensure such a result is by considering resource usage.

Thus, in an embodiment, the set of unassigned application instances is first sorted based on resource usage. For example, there are four unassigned application instances: I1, I2, I3, and I4. An average (or median or maximum, etc.) CPU usage of each application instance over a period of time (e.g., the last two weeks) is calculated and the application instances are sorted based on CPU usage from highest to lowest. Thus, the application instance associated with the highest CPU usage is placed first in an ordered list and the application instance associated with the lowest CPU usage is placed last in the ordered list. For example, after sorting the foregoing application instances based on CPU usage, the ordered list of unassigned application instances is as follows: I3, I1, I4, I2.

Then, when selecting the first application instance for a machine (i.e., when no application instance has yet been selected), the first application instance in the ordered list (i.e., the most resource intensive) is selected. In this example, I3 would be selected. Later, when adding the second application instance for the machine, the last application instance in the ordered list (i.e., the least used) is selected. In this example, I2 would be selected. Repeatedly selecting (a) the application instance in the ordered list with the highest resource usage and (b) the application instance in the ordered list with the lowest resource usage is referred to as the “zig zag approach.”

Thus, different iterations of block 120 (when considering the same machine) will alternate in selecting, from the set of unassigned application instances, the most resource intensive application instance and the least resource instance application instance.

A variation of the zig zag approach is to first select (during the odd numbered iterations of block 120, with respect to a particular machine) the last application instance in the ordered list (i.e., the least resource intensive) and then select (during even numbered iterations of block 120, with respect to the particular machine) the first application instance in the ordered list.

### Machine “Health”

In an embodiment, the “health” of a machine is considered before assigning application instance to the machine. Such “health” refers to the flatness of the resulting resource usage (or usages if multiple resource types are considered) on the time series data points. Because the resource capacity of a machine is typically flat (e.g., CPU or memory), a preferred state of a machine is to have flat resource usage, which leaves more space for later adding more application instances.

For example, three application instances are assigned to a machine and only five data points in the time series data for each application instance. A result of adding the resource usage of each application instance is the following percentages, one for each time instant: 63, 54, 57, 65, 61. One way to determine the “health” of the machine is to calculate a variance, which involves calculating the average of the four numbers (60 in this example), calculating a difference between each data point and the average (3, −6, −3, 5, 1), summing the squares of each calculated difference (9+36+9+25+1), and dividing the sum by the average (80/60, or about 1.33). In this example, the variance is relatively low and, thus, the machine is considered “healthy.” Metrics other than variance may be used, such as standard deviation. Embodiments are not limited to any particular type of metric that indicates a flatness of the combined resource usage of multiple application instances.

In an embodiment, if adding a selected application instance to a machine would cause the variance (or other metric) to exceed a particular value, then another application instance from the set of unassigned application instances is considered.

In a related embodiment, when determining which an application instance to assign to a machine, multiple application instances may be considered. For example, block 120 may involve selecting the three application instances from the set of unassigned application instances. If the set of unassigned application instances is ordered, then the first iteration of block 120 (with respect to the currently selected machine) may involve selecting the first three application instances, which are the three most resource intensive instances with respect to a particular resource. The health of the selected machine is calculated, once for each of the three selected application instances. The application instance associated with the best “health” (e.g., the lowest variance or standard deviation) is assigned to the selected machine.

In an embodiment, multiple resource types are considered when determining a health of a machine if a particular application instance is to be assigned to the machine. In this embodiment, a health metric is calculated for each resource type. In order to be able to compare health metrics of each resource type, the time series data of each resource type may be converted to a percentage, such as 80% memory usage, instead of an actual magnitude, such as 8.8 GB of memory. That way, the health metric of each resource type is in the same unites.

Then, a determination of whether assigning the particular application instance to the machine would exceed a certain health threshold may involve one or more techniques, such as determining whether the health metric (from among the multiple health metrics) indicating the least flatness or the most variation (e.g., a high variance value) is above a certain threshold and, if so, then another application instance is considered. Another technique involves calculating an average of the multiple health metrics associated with the particular application instance and comparing the average to a particular threshold. A similar technique involves determining the median health metric and comparing that value to the particular threshold.

### Identifying the Most Restricting Resource Type

In an embodiment where multiple resource types are considered, process 100 may first involve identifying the most restricting resource type, which is defined as the resource type that requires the most machines if each resource type was considered individually and separately from other resource types. For example, if only CPU was considered, then 27 machines would be required; if only memory was considered, then 12 machines would be required; and if only disk I/O was considered, then 19 machines would be required. In this example, CPU is the most restricting resource type.

One approach to identifying the most restricting resource type is to run process 100 to completion for each resource type. Block 130 would involve considering just one resource type. Thus, if there are five resource types, process 100 would be run five times. Each run of process 100 may involve the zig zag approach, sorting the set of unassigned application instances, and/or considering the health of each machine before assigning an application instance to the machine.

After each run of process 100, a number of machines is identified. In other words, the number of machines required to assign all application instances in the set of unassigned application instances is known for the corresponding resource type. That number is compared to the other numbers identified after running process 100 for the other resource types. The resource type associated with the highest number is selected as the most restricting resource type.

After the most restricting resource is identified, process 100 may be run again, but this time considering all relevant resource types of an application instance when determining (in block 130) whether the application instance can be assigned to a machine.

In a related embodiment, when identifying the most restricting resource, instead of adding time series data, an average (or median or other aggregate measure of) resource usage of an application instance may be first computed and added to set of accumulated averages (or medians, etc.) of application instances already assigned to the current selected machine.

### Another Example Process

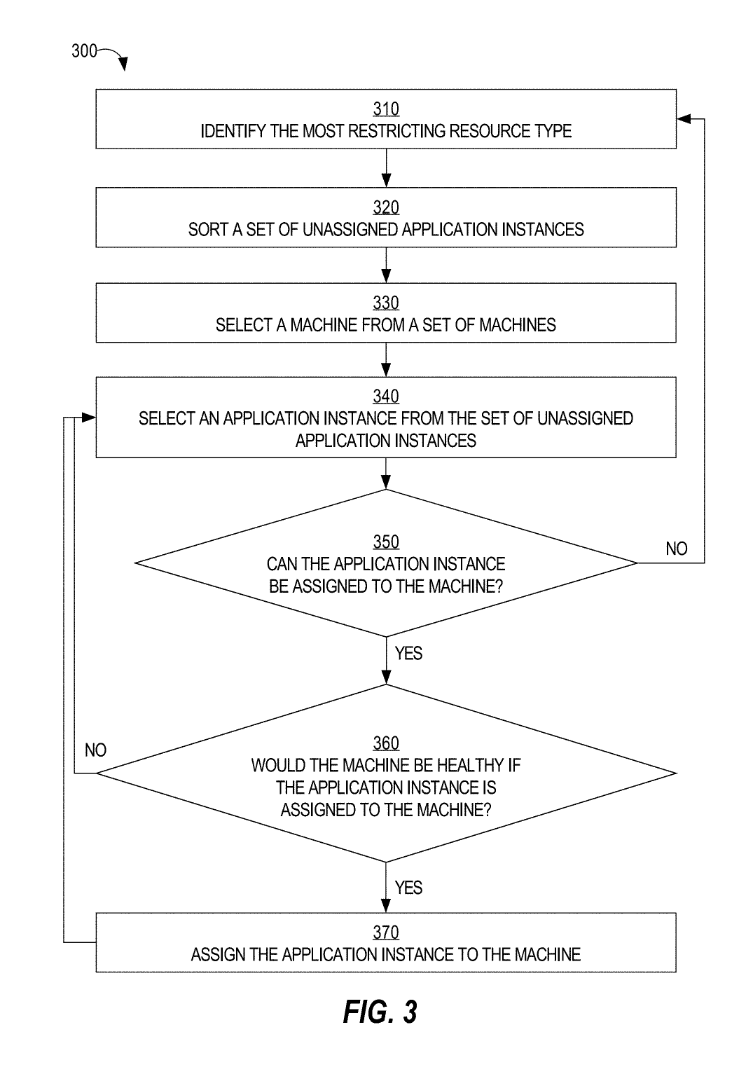

FIG. 3 is a flow diagram that depicts a process 300 for assigning application instances to machines, in an embodiment. Process 300 may be implemented in software, hardware, or any combination of software and hardware. Process 300 relies on some of the techniques described previously. Process 300 begins a set of machines and a set of unassigned application instances.

At block 310, the most restricting resource type is identified. Block 310 is performed if multiple resource types are considered when determining whether to assign an application instance to a machine (which may already be assigned one or more application instances).

If this is the second iteration of 310, then a different most restricting resource type may be identified since, after one or more application instances are assigned to a machine (and removed from the set of unassigned application instances), the most restricting resource type may change.

At block 320, the set of unassigned application instances is sorted by resource usage of the most restricting resource type. Block 320 is optional if, when an application instance is selected from the set of unassigned application instances (in block 340), the resource capacity of the application instance is considered in making the selection. For example, the most resource intensive application instance may be selected or the least resource intensive application instance may be selected.

At block 330, select a machine from the set of machines. If all the machines in the set of machines are identical in terms of resource capacity, then any machine from the set may be selected. If there are at two machines in the set that are different in terms of resource capacity, then any approach for selecting a machine may be used, such as selecting the most resource constrained machine, selecting the least resource constrained machine, or randomly selecting a machine.

At block 340, based on the order of the list of unassigned application instances, an application instance is selected from the list. For example, the first application instance in the list may be the application instance in the list that uses the identified resource type the most of all the application instances in the list.

At block 350, it is determined whether the selected application instance (based on its time series data) can be assigned to the selected machine (without exceeding the selected machine's one or more relevant resource capacities). If so, then process 300 proceeds to block 360; else, process 300 may proceed to block 340 to select another application instance from the list. Alternatively, if the determination in block 350 results in the negative, then process 300 may return to block 310. A negative determination in block 350 may indicate that the machine cannot be assigned any more application instances from the set (or list) of unassigned application instances.

At block 360, it is determined whether the machine would be “healthy” if the selected application instance is assigned to the machine. If so, then process 300 proceeds to block 370; else, process 300 returns to block 340, where another application instance is selected. For example, if the selected application instance is the most resource intensive application instance in the list, then the next iteration of block 340 would select the second most resource intensive application instance in the list. As another example, if the selected application instance is the least resource intensive application instance in the list, then the next iteration of block 340 would select the second least resource intensive application instance in the list.

In a variation of blocks 340-360, block 340 may involve selecting multiple application instances from the list (e.g., the three most resource intensive application instances), block 350 may involve determining whether each of the selected application instances can be assigned to the selected machine, and block 360 may involve determining, for each selected application instance that can be assigned to the selected machine, whether the machine would be healthy if the selected application instance is assigned to the selected machine. Thus, each of blocks 340-360 may involve considering multiple application instances. If multiple application instances can be assigned to the selected machine and each individual assignment would result in a “healthy” machine, then the application instance that would result in the most “healthy” machine is assigned in block 370.

At block 370, the selected application instance is assigned to the selected machine and the machine's one or more sets of accumulated time series data is updated based on the one or more sets of time series data of the selected application instance. Block 370 also involves removing the selected application instance from the set (or list) of unassigned application instances.

Process 300 then returns to block 340 where another application instance from the list is selected. The selection may be from the opposite end of the list from where the selected application instance was selected. For example, if the selected application instance in the first iteration of block 340 was the first in the list, then the next application instance to select in the second iteration of block 340 will be the last in the list. This is part of the zig zap technique described previously.

### Cyclic Usage Pattern

In an embodiment, only application instances that reflect a cyclic resource usage pattern (at least with respect to one resource type) are candidates for process 100. A cyclic resource pattern may result from cyclic online user behavior. For example, more client devices may connect to an online service during waking hours than during sleeping hours and the number of client devices that do connect on a daily basis does not change significantly. Application instances that do not exhibit a cyclic resource usage pattern may be assigned manually or in some other way. Instead, such application instances may exhibit seemingly random resource usage, in which case it may not be useful assigning them to a machine that is already assigned one or more other application instances.

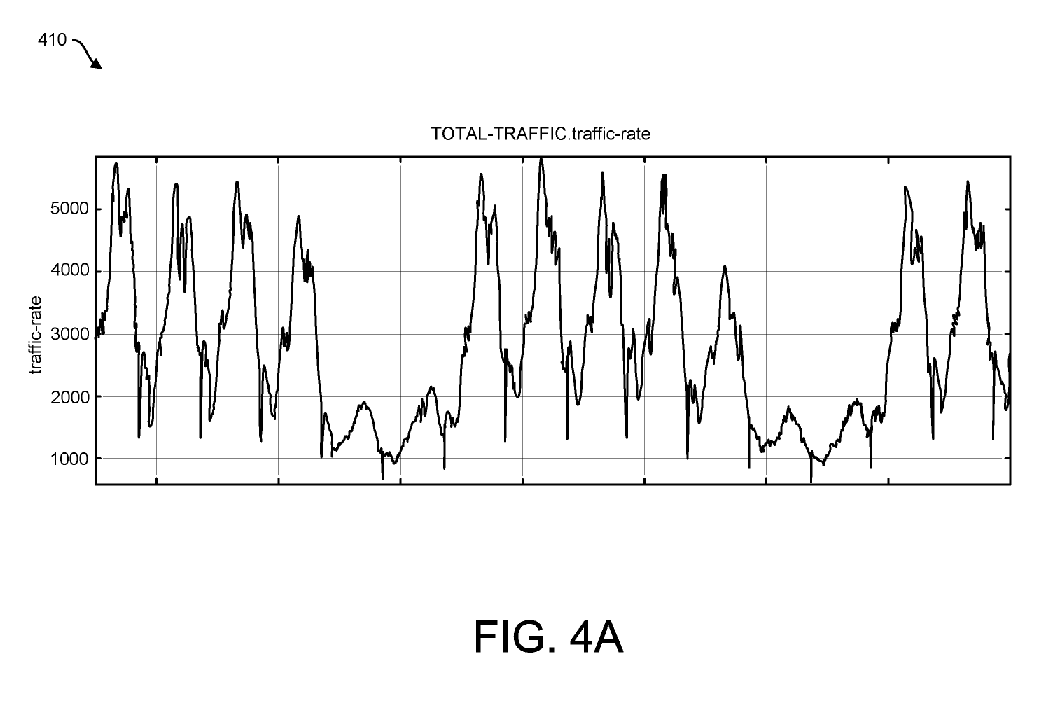

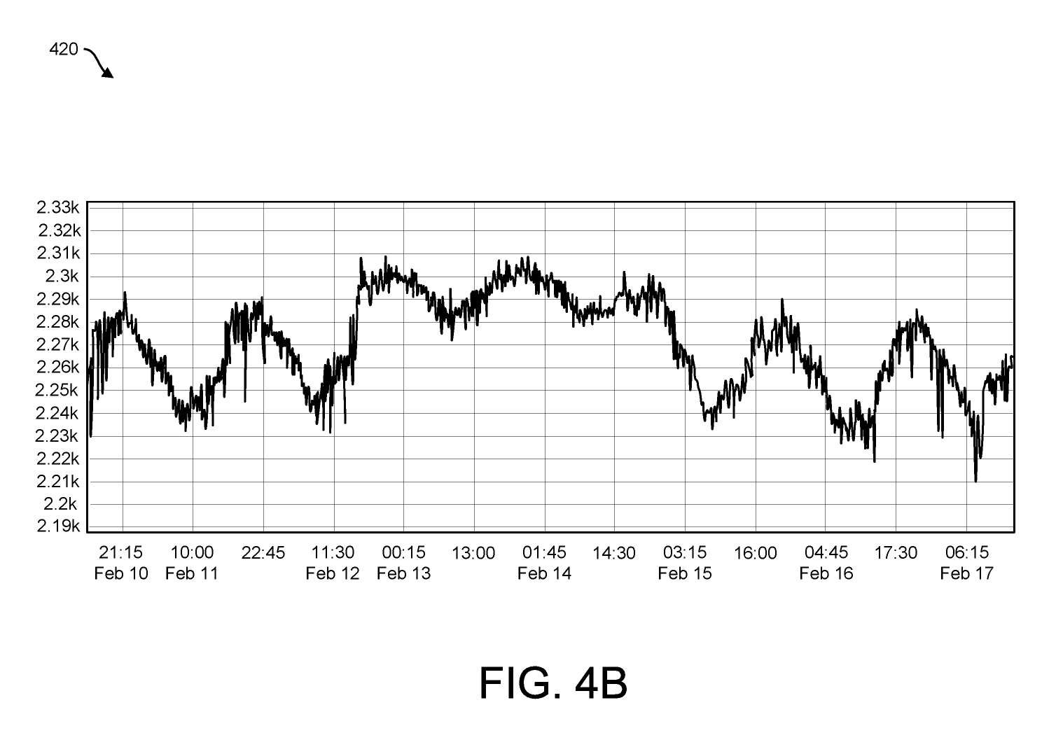

FIGS. 4A-4B are diagrams that depict, respectively, a chart 410 illustrating cyclic online user behavior and a chart 420 illustrating cyclic resource usage of a particular application instance. The x-axis on each chart represents time. The y-axis in chart 410 represents a number of user requests while the y-axis in chart 420 represents CPU usage. If an application instance uses certain resources in a regular pattern (e.g., constant or cyclical) over time, then those responsible for assigning application instances to machines will be confident that that pattern will continue.

Cyclic resource usage pattern may be detected manually (e.g., by a user viewing a resource usage chart similar to chart 410) or automatically. An example automatic technique involves comparing two sets of time series data, each corresponding to a different time period but where the time periods are of equal length (e.g., two weeks). Also, the days or hours on which each time series data begins and ends are the same. For example, each time series data begins on a Sunday at 7 am Pacific time and ends on a Saturday at 11 pm Pacific time.

A comparison of two sets of time series data may comprise a difference, involving a number of subtractions equal to the number of data points in one set of time series data. For example, if there are 672 data points in one set of time series data, then differencing two sets of time series data would involve 672 difference operations. The 672 results would then be analyzed. For example, an average of each absolute difference may be calculated. If the average is less than a certain threshold (or is a percentage, of an average/median magnitude of one or both sets of time series data, that is less than a threshold percentage), then the application instance may be considered for assigning to a machine using one or more techniques described herein.

In a related example, instead of differencing two sets of time series data, each set of time series data is normalized, which involves summing the data values in the set of time series data to calculate a total value and, for each data value (corresponding to a different point in time), the data value is divided by the total value. After each set of time series data is normalized, the two sets of normalized time series data are differenced, resulting in multiple data values, the total of which cannot be greater than the number of data values in one of the sets of time series data. A threshold value may be established where, if the total of the resulting data values after the difference is less than the threshold value, then the corresponding application instance is deemed to exhibits sufficient cyclic behavior; otherwise, the application instance is deemed to not exhibit sufficient cyclic behavior.

### Triggering a Reassignment

After a set of application instances are assigned and deployed to a set of machines, such assignment may change. Triggering such a change may be a result of user input, such as input from a machine administrator who is responsible for managing the set of machines, which may comprise all or a significant number of machines in a data center. Alternatively, the change may be triggered automatically based on one or more criteria.

In an embodiment, resource usage of one or more application instances is used to determine whether a current mapping of application instances to machines should be updated. If the usage patterns of one or more application instances (or a threshold number of instances and/or application types) change substantially, then such a detection may trigger an automatic reassignment. Another example trigger is if certain number of machines (e.g., one, five, or 10% of all machines) experience a resource capacity scarcity (e.g., 100% CPU, 95% memory usage, 1 Gbps network I/O). Another example trigger a level of fragmentation, occurrence or level of thrashing, which is the rapid exchange of data in memory for data in persistent storage to the exclusion of all or most application-level processing.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

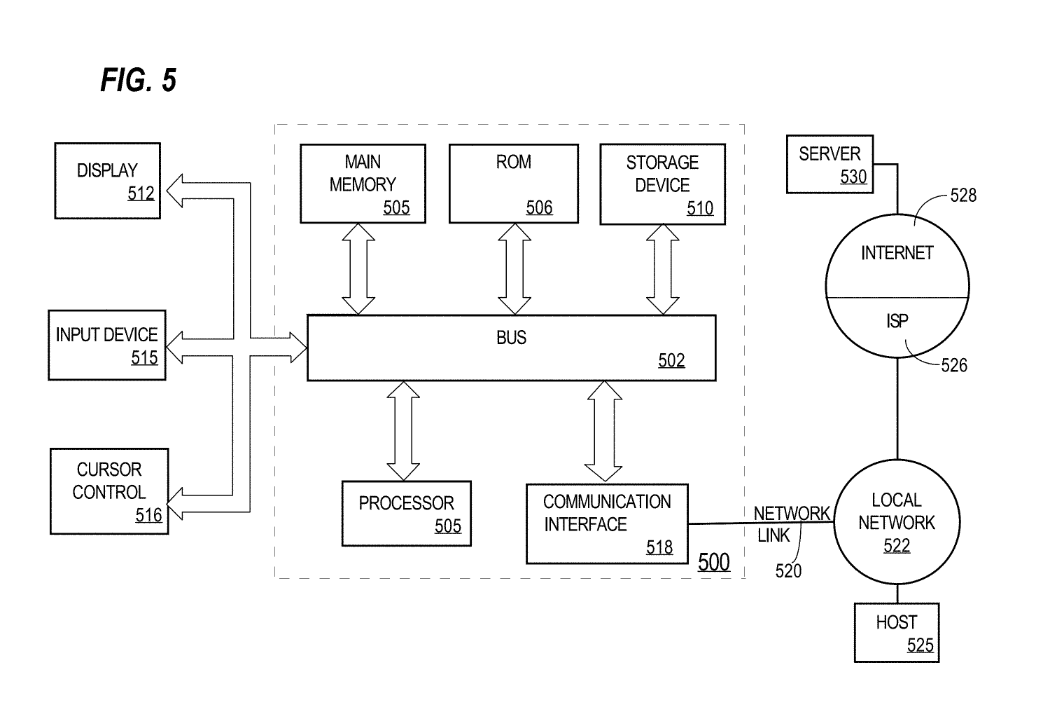

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by one or more processors, cause:
determining a first resource usage of a particular resource by a first application instance over a period of time;
determining a second resource usage of the particular resource by a second application instance over the period of time, wherein the second application instance is different than the first application instance;
aggregating the first resource usage and the second resource usage to generate an aggregated resource usage;
based on the aggregated resource usage, determining whether to assign the first application instance and the second application instance to a particular machine.

2. The system of claim 1, wherein the particular resource is one of CPU, memory, persistent storage I/O, network I/O, or persistent storage.

3. The system of claim 1, wherein:
the first resource usage of the particular resource by the first application instance includes a first plurality of data values;
the second resource usage of the particular resource by the second application instance includes a second plurality of data values;
the aggregated resource usage includes a third plurality of data values;
determining whether to assign comprises determining whether any data value in the third plurality of data values is greater than a particular capacity threshold.

4. The system of claim 3, wherein the particular capacity threshold is less than an actual resource capacity of the particular resource of the particular machine.

5. The system of claim 3, wherein the particular capacity threshold is associated with the particular machine and is different than a second capacity threshold that is associated with a second machine that is different than the particular machine.

6. The system of claim 1, wherein the instructions, when executed by the one or more processors, further cause:
assigning the first application instance and the second application instance to the particular machine;
removing the first application instance and the second application instance from a set of application instances to create an updated set of application instances;
determining, from the updated set of application instances, a subset of application instances based on resource usage by each application instance in the subset of application instances;
assigning the subset of application instances to a second machine that is different than the particular machine.

7. The system of claim 6, wherein the instructions, when executed by the one or more processors, further cause:
for each application instance in the set of application instances, calculating an aggregate value based on usage of the particular resource over the period of time;
ranking the set of application instances based on the aggregate value calculated for each application instance in the set of application instances.

8. A method comprising:
determining a first resource usage of a particular resource by a first application instance over a period of time;
determining a second resource usage of the particular resource by a second application instance over the period of time, wherein the second application instance is different than the first application instance;
aggregating the first resource usage and the second resource usage to generate an aggregated resource usage;
based on the aggregated resource usage, determining whether to assign the first application instance and the second application instance to a particular machine;
wherein the method is performed by one or more computing devices.

9. The method of claim 8, wherein the particular resource is one of CPU, memory, persistent storage I/O, network I/O, or persistent storage.

10. The method of claim 8, wherein:
the first resource usage of the particular resource by the first application instance includes a first plurality of data values;
the second resource usage of the particular resource by the second application instance includes a second plurality of data values;
the aggregated resource usage includes a third plurality of data values;
wherein determining whether to assign comprises determining whether any data value in the third plurality of data values is greater than a particular capacity threshold.

11. The method of claim 10, wherein the particular capacity threshold is less than an actual resource capacity of the particular resource of the particular machine.

12. The method of claim 10, wherein the particular capacity threshold is associated with the particular machine and is different than a second capacity threshold that is associated with a second machine that is different than the particular machine.

13. The method of claim 8, further comprising:
assigning the first application instance and the second application instance to the particular machine;
removing the first application instance and the second application instance from a set of application instances to create an updated set of application instances;
determining, from the updated set of application instances, a subset of application instances based on resource usage by each application instance in the subset of application instances;
assigning the subset of application instances to a second machine that is different than the particular machine.

14. The method of claim 13, further comprising:
for each application instance in the set of application instances, calculating an aggregate value based on usage of the particular resource over the period of time;
ranking the set of application instances based on the aggregate value calculated for each application instance in the set of application instances.

15. The method of claim 13, further comprising:
prior to assigning the first application instance and the second application instance to the first machine, for each application instance in the set of application instances, determining a second resource usage of a second resource by said each application instance over the period of time, wherein the second resource usage of the second resource by said each application instance includes multiple data values;
wherein the particular resource is a different type of resource than the second resource;
wherein determining comprises:
identifying a first set of multiple data values that reflects usage of the second resource by the first application instance over the period of time;
identifying a second set of multiple data values that reflects usage of the second resource by the second application instance over the period of time;
adding the first set of multiple data values to the second set of multiple data values to generate a third set of multiple data values;
determine whether any data value in the third set of multiple data values is greater than a second capacity threshold that is different than the particular capacity threshold.

16. The method of claim 13, further comprising:
identifying, from among the set of application instances, a particular application instance that experiences the most usage of the particular resource;
adding the particular application instance to a first subset of application instances and removing the particular application instance from the set of application instances;
after adding the particular application instance to the first subset, identifying, from among the set of application instances, a certain application instance that experiences the least resource usage;
adding the certain application instance to the first subset prior to considering any other application instance in the set of application instances for adding to the first subset;
after adding the certain application instance to the first subset, removing the certain application instance from the set of application instances.

17. The method of claim 16, further comprising:
for each application instance of multiple application instances in the set of application instances, calculating a health value that indicates a health level of said each application instance, wherein the multiple application instances include the first application instance and a third application instance that is different than the first application instance;
identifying, based on the health value of the first application instance relative to the health value of each other application instance in the multiple application instances, the first application instance for consideration to assign to the particular machine.

18. The method of claim 17, wherein:
calculating the health value of said each application instance in the multiple application instances comprises calculating a variance of a plurality of data values associated with said each application instance;
the health value of said each application instance is based on the variance.

19. The method of claim 13, further comprising:
determining resource usage of each resource, of a plurality of resources, by each application instance in a set of application instances that includes the first application instance and the second application instance;
wherein the plurality of resources includes a first resource and a second resource that is different than the first resource;
for each resource of the plurality of resources, determining, based on the resource usage of said each resource utilized by each application instance in the set of application instances, a number of machines to which the set of application instances can be assigned without exceeding a resource capacity of any of the machines;
wherein determining the number of machines comprises determining a first number of machines for the first resource and determining a second number of machines for the second resource;
wherein the first number of machines is different than the second number of machines;
identifying the particular resource, from among the plurality of resources, based on the particular resource being associated with the highest number of machines.

20. The method of claim 19, wherein:
identifying the particular resource is performed prior to assigning the first application instance and the second application instance to the particular machine and prior to determining the subset;
the method comprising:
after removing the first application instance and the second application instance from the set of application instances and prior to determining the subset, for each resource of the plurality of resources, determining, based on the resource usage of said each resource utilized by each application instance in the updated set of application instances, an updated number of machines to which the updated set of application instances can be assigned without exceeding a resource capacity of any of the machines;
wherein determining the updated number of machines comprises determining a third number of machines for the first resource and determining a fourth number of machines for the second resource;
wherein the third number of machines is different than the first number of machines and the fourth number of machines;
determining a certain resource, of the plurality of resources, that is associated with the highest updated number of machines.
